(19) United States
(12) Patent Application Publication
(10) Pub. No.: US 2021/0398447 A1
(43) Pub. Date: Dec. 23, 2021

(54) BRAZING WORK ASSISTANCE METHOD, RECORDING MEDIUM, AND BRAZING WORK ASSISTANCE SYSTEM

(71) Applicant: Panasonic Intellectual Property Management Co., Ltd., Osaka (JP)

(72) Inventors: Kazuhiko KOKUBU, Shiga (JP); Toshiki KUMA, Osaka (SG)

(21) Appl. No.: 17/290,611

(22) PCT Filed: Oct. 25, 2019
(86) PCT No.: PCT/JP2019/041931

§ 371 Date: Apr. 30, 2021

(30) Foreign Application Priority Data
Nov. 16, 2018 (JP) 2018-215746

(51) Int. Cl. G09B 19/00; B23K 3/08

(52) U.S. Cl. CPC G09B 19/00; B23K 3/08

(57) ABSTRACT

A brazing work assistance method includes: displaying (i) a first reference range indicating a range between an upper value and a lower value obtained from a first temperature waveform that is a model temperature waveform of a brazing portion in the brazing work, and (ii) a measured waveform that is a temperature waveform of the brazing portion brazed during the brazing work conducted by the worker; and displaying a second reference range according to the measured waveform when the measured waveform falls outside the first reference range. The second reference range indicates a range between an upper value and a lower value obtained from a second temperature waveform and is different from the first reference range. The second temperature waveform is a model temperature waveform of the brazing portion in the brazing work, is different from the first temperature waveform.

### TECHNICAL FIELD

The present disclosure relates to a brazing work assistance method, a program, and a brazing work assistance system.

### BACKGROUND ART

Welding work, such as brazing, is work that relies on the senses of workers. Therefore, it is difficult to instruct the details of work using an instruction manual. In this regard, Patent Literature (PTL) 1 discloses the system that evaluates the proficiency level of workers by comparing, with the model pattern, the time-series pattern of measured values of temperature etc.

### CITATION LIST

### Patent Literature

[PTL 1] Japanese Unexamined Patent Application Publication No. 2006-171184

### SUMMARY OF INVENTION

### Technical Problem

The technique disclosed in PTL 1 provides the evaluations of the proficiency levels of workers, but does not provide assistance for actual work to facilitate the production of non-defective products.

The present disclosure aims to provide a brazing work assistance method, a program, or a brazing work assistance system which can assist a worker in conducting brazing work.

### Solution to Problem

A brazing work assistance method according to an aspect of the present disclosure is a brazing work assistance method for assisting a worker in conducting brazing work. The brazing work assistance method includes: displaying (i) a first reference range indicating a range between an upper value and a lower value obtained from a first temperature waveform that is a model temperature waveform of a brazing portion in the brazing work, and (ii) a measured waveform that is a temperature waveform of the brazing portion brazed during the brazing work conducted by the worker, the first temperature waveform being obtained in advance; and displaying a second reference range according to the measured waveform when the measured waveform falls outside the first reference range, the second reference range indicating a range between an upper value and a lower value obtained from a second temperature waveform and being different from the first reference range, the second temperature waveform being a model temperature waveform of the brazing portion in the brazing work, being different from the first temperature waveform, and being obtained in advance.

Note that these general or specific aspects of the present disclosure may be implemented using a system, a method, an integrated circuit, a computer program, a computer-readable recording medium such as a CD-ROM, or any optional combination of systems, methods, integrated circuits, computer programs, or computer-readable recording media.

### Advantageous Effects of Invention

The present disclosure can provide a device for a brazing work assistance method, a program, or a brazing work assistance system which can assist a worker in conducting brazing work.

### BRIEF DESCRIPTION OF DRAWINGS

FIG. 1 is a diagram illustrating a configuration of a brazing work assistance system according to an embodiment.

FIG. 2 is a flowchart illustrating processing performed by the brazing work assistance system according to the embodiment.

FIG. 3 is a diagram illustrating an example of an indication on a display according to the embodiment.

FIG. 4 is a diagram illustrating an example of a plurality of reference ranges according to the embodiment.

FIG. 5 is a diagram illustrating an example of an indication when a measured waveform according to the embodiment falls outside a reference range.

FIG. 6 is a diagram illustrating an example of an indication when the measured waveform according to the embodiment falls outside the reference range.

FIG. 7 is a diagram illustrating an example of time intervals according to the embodiment.

FIG. 8 is a diagram illustrating an example of a plurality of reference ranges that correspond to a plurality of levels of skill according to the embodiment.

FIG. 9 is a diagram illustrating relationships between the time intervals and the levels of skill, and qualities according to the embodiment.

FIG. 10 is a diagram illustrating an example of an indication when the measured waveform according to the embodiment falls outside the reference range.

FIG. 11 is a diagram illustrating an example of an indication when the measured waveform according to the embodiment falls outside the reference range.

FIG. 12 is a diagram illustrating an example of an indication of a reference waveform according to the embodiment.

FIG. 13 is a block diagram illustrating a brazing work assistance device that performs machine learning according to the embodiment.

### DESCRIPTION OF EMBODIMENTS

A brazing work assistance method according to an aspect of the present disclosure is a brazing work assistance method for assisting a worker in conducting brazing work. The brazing work assistance method includes: displaying (i) a first reference range indicating a range between an upper value and a lower value obtained from a first temperature waveform that is a model temperature waveform of a brazing portion in the brazing work, and (ii) a measured waveform that is a temperature waveform of the brazing portion brazed during the brazing work conducted by the worker, the first temperature waveform being obtained in advance; and displaying a second reference range according to the measured waveform when the measured waveform falls outside the first reference range, the second reference range indicating a range between an upper value and a lower value obtained from a second temperature waveform and being different from the first reference range, the second temperature waveform being a model temperature waveform of the brazing portion in the brazing work, being different from the first temperature waveform, and being obtained in advance.

In the brazing work assistance method, the first reference range and the measured waveform are displayed as described above. With this, the worker can readily determine whether the temperature during the work is appropriate, and can adjust the temperature of the brazing portion to an appropriate value. Furthermore, the second reference range according to the measured waveform is displayed when the measured waveform falls outside the first reference range. With this, even when the measured waveform falls outside the first reference range, the worker can continue with the work with reference to the new second reference range.

For example, among a plurality of reference ranges, a reference range having the highest correlation with the measured waveform may be displayed as the second reference range.

With this, in the brazing work assistance method, it is possible to display the second reference range appropriate for the current measured waveform.

For example, a reference range displayed as the second reference range when the measured waveform exceeds an upper limit of the first reference range and a reference range displayed as the second reference range when the measured waveform falls below a lower limit of the first reference range may be different.

With this, in the brazing work assistance method, it is possible to display the second reference range appropriate for the current measured waveform.

For example, a different reference range may be displayed as the second reference range according to a level of skill of the worker.

With this, in the brazing work assistance method, it is possible to display an appropriate second reference range according to the level of skill of the worker.

For example, when a level of skill of the worker is a first level of skill, a third reference range may be displayed as the second reference range. When a level of skill of the worker is a second level of skill which is lower in the level of skill than the first level of skill, a fourth reference range may be displayed as the second reference range. The third reference range may indicate a range of a model temperature waveform for conducting a first quality of brazing work. The fourth reference range may indicate a range of a model temperature waveform for conducting a second quality of brazing work which is lower in quality than the first quality of brazing work.

With this, in the brazing work assistance method, it is possible to display the second reference range provided for a low level of work difficulty when the level of skill of the worker is low. Therefore, it is possible to prevent the worker from making mistakes in brazing work.

For example, when time elapsed since the start of the brazing work is shorter than a predetermined reference time, the same reference range may be displayed as the second reference range regardless of the level of skill of the worker. When the time elapsed is longer than the predetermined reference time, a different reference range may be displayed according to the level of skill of the worker.

With this, in the brazing work assistance method, it is possible to display the second reference range provided for a low level of work difficulty when the measured waveform falls outside the first reference range and when the level of work difficulty likely to increase. Therefore, the worker can be prevented from making mistakes in brazing work.

For example, the first reference range and the second reference range may be generated through machine learning.

With this, in the brazing work assistance method, it is possible to generate an appropriate first reference range and an appropriate second reference range through machine learning.

For example, the second reference range may be generated from the measured waveform through machine learning.

With this, in the brazing work assistance method, it is possible to generate an appropriate second reference range according to the measured waveform through machine learning.

A program according to an aspect of the present disclosure causes a computer to execute the brazing work assistance method described above.

A brazing work assistance system according to an aspect of the present disclosure is a brazing work assistance system that assists a worker in conducting brazing work. In the brazing work assistance system, (i) a first reference range indicating a range between an upper value and a lower value obtained from a first temperature waveform that is a model temperature waveform of a brazing portion in the brazing work, and (ii) a measured waveform that is a temperature waveform of the brazing portion brazed during the brazing work conducted by the worker are displayed, the first temperature waveform being obtained in advance; and a second reference range according to the measured waveform is displayed when the measured waveform falls outside the first reference range, the second reference range indicating a range between an upper value and a lower value obtained from a second temperature waveform and being different from the first reference range, the second temperature waveform being a model temperature waveform of the brazing portion in the brazing work, being different from the first temperature waveform, and being obtained in advance.

In the brazing work assistance system, the first reference range and the measured waveform are displayed as described above. With this, the worker can readily determine whether the temperature during the work is appropriate, and can adjust the temperature of the brazing portion to an appropriate value. Furthermore, the second reference range according to the measured waveform is displayed when the measured waveform falls outside the first reference range. With this, even when the measured waveform falls outside the first reference range, the worker can continue with the work with reference to the new second reference range.

Note that these comprehensive or specific aspects of the present disclosure may be implemented by a system, a method, an integrated circuit, a computer program, or a computer-readable recording medium such as a CD-ROM, or by any optional combination of systems, methods, integrated circuits, computer programs, and recording media.

Hereinafter, embodiments will be described in detail with reference to the drawings. Note that the embodiments described below each display a specific example of the present disclosure. The numerical values, shapes, materials, elements, the arrangement and connection of the elements, steps, and the processing order of the steps, etc. presented in the embodiments below are mere examples, and are not intended to limit the present disclosure. Therefore, among the elements in the following embodiments, elements not recited in any of the independent claims defining the most generic part of the inventive concept are described as optional elements. In addition, the drawings are schematic diagrams, and do not necessarily provide strictly accurate illustration.

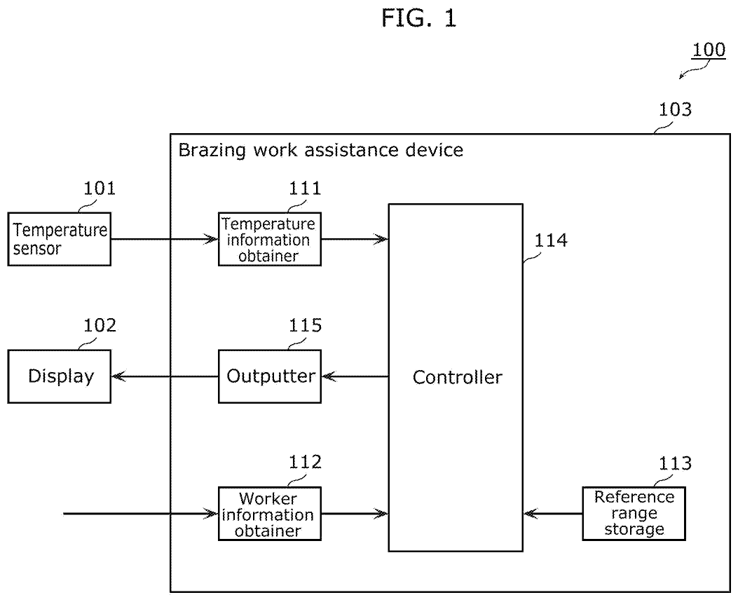

First, a configuration of brazing work assistance system 100 according to an embodiment will be described. FIG. 1 is a block diagram illustrating the configuration of brazing work assistance system 100 according to the embodiment. Brazing work assistance system 100 is a system for assisting a worker in conducting brazing work. This brazing work assistance system 100 includes temperature sensor 101, display 102, and brazing work assistance device 103.

Temperature sensor 101 obtains the temperature of a brazing portion in brazing work. Temperature sensor 101 is, for example, an infrared camera. Note that temperature sensor 101 may be a single sensor, a plurality of sensors arranged in an array, or a plurality of sensors that obtain the temperature of the brazing portion from a plurality of directions.

Display 102 displays information to a worker. Display 102 is, for example, a liquid crystal display.

Brazing work assistance device 103 displays, on the liquid crystal display, (i) a first reference range indicating a range between the upper value and the lower value obtained from a first temperature waveform that is a model temperature waveform of a brazing portion in brazing work and is obtained in advance, and (ii) a measured waveform that is a temperature waveform of a brazing portion brazed during the brazing work conducted by a worker. In addition, when the measured waveform falls outside the first reference range, brazing work assistance device 103 displays, on display 102, a second reference range according to the measured waveform. The second reference range indicates a range between the upper value and the lower value obtained from a second temperature waveform, and is different from the first reference range. The second temperature waveform is a model temperature waveform of the brazing portion in the brazing work, is different from the first temperature waveform, and is obtained in advance.

This brazing work assistance device 103 includes temperature information obtainer 111, worker information obtainer 112, reference range storage 113, controller 114, and outputter 115. Note that brazing work assistance device 103 is, for example, a computer that includes a processor, such as a central processing unit (CPU), and a memory on which a program is recorded. For example, the functions of processors are implemented by the above-described processor executing the above-described program.

Temperature information obtainer 111 obtains, during the brazing work conducted by a worker, a measured waveform obtained by temperature sensor 101. The measured waveform is a temperature waveform of a brazing portion. That is, the measured waveform indicates the time series of changes in temperature of the brazing portion brazed during the brazing work.

Worker information obtainer 112 obtains the information of a worker who conduct the brazing work. Specifically, this information includes the level of skill of the worker in brazing work. Note that the method of inputting the information is not particularly limited, but the worker may perform an input operation via a touchpad etc., or the information of the worker may be read from, for example, an integrated circuit (IC) tag that the worker possesses.

Reference range storage 113 stores a plurality of reference ranges each of which indicates the range of a model temperature waveform of a brazing portion in brazing work.

Controller 114 selects one reference range among the plurality of reference ranges according to the measured waveform and the level of skill of a worker, and outputs the selected reference range to display 102 via outputter 115. In addition, controller 114 outputs the measured waveform to display 102 via outputter 115.

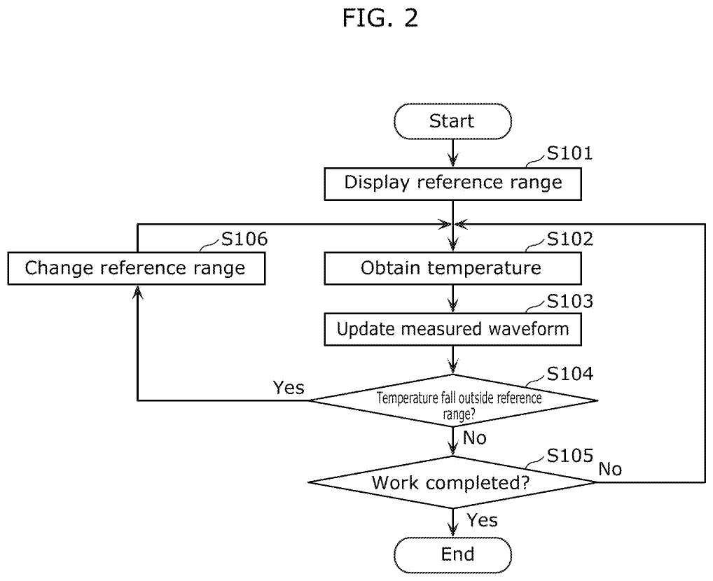

Next, operation performed by brazing work assistance system 100 will be described. FIG. 2 is a flowchart illustrating operation performed by brazing work assistance system 100.

First, controller 114 selects, among the plurality of reference ranges stored in reference range storage 113, reference range 201A (first reference range) which is the default, and outputs the default reference range 201A to display 102. Display 102 displays the default reference range 201A (S101). Among the plurality of reference ranges, the default reference range 201A is a reference range provided for the lowest level of work difficulty.

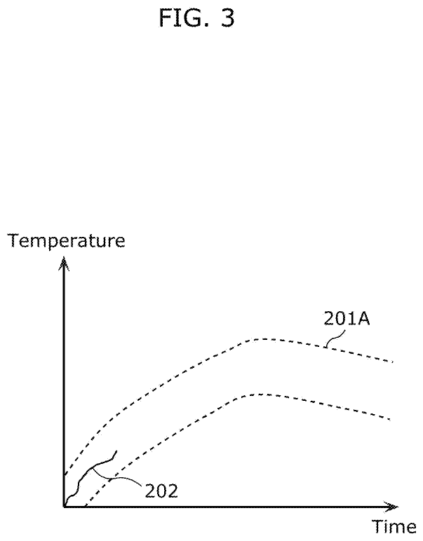

FIG. 3 is a diagram illustrating an example of an indication that is displayed on display 102. As illustrated in FIG. 3, reference range 201A, which is the default, is displayed.

Next, temperature information obtainer 111 obtains temperature obtained by temperature sensor 101 (S102), and controller 114 updates measured waveform 202 that is displayed on display 102 (S103). With this, measured waveform 202 is updated in real time at predetermined time intervals.

Next, controller 114 determines whether the updated measured waveform 202 (that is, the current temperature) falls outside a reference range (in this case, reference range 201A) which is currently displayed (S104). When the updated measured waveform 202 does not fall outside the reference range that is currently displayed (No in S104), controller 114 determines whether brazing work is completed (S105). For example, controller 114 determines that the brazing work is completed when a predetermined time has elapsed since the start of the brazing work, and determines that the brazing work is not completed when the predetermined time has not elapsed since the start of the brazing work. Note that a worker may perform an operation that indicates the completion of work.

When the brazing work is not completed (No in S105), brazing work assistance device 103 performs again the processes from step S102 onward. That is, the processes from step S102 to S104 are repeatedly performed at predetermined time intervals.

In contrast, when the brazing work is completed (Yes in S105), brazing work assistance device 103 ends the processing.

In addition, when the updated measured waveform 202 falls outside the reference range that is currently displayed (Yes in S104), controller 114 updates the reference range displayed (S106). Specifically, controller 114 selects a reference range according to the current measured waveform 202 among the plurality of reference ranges stored in reference range storage 113.

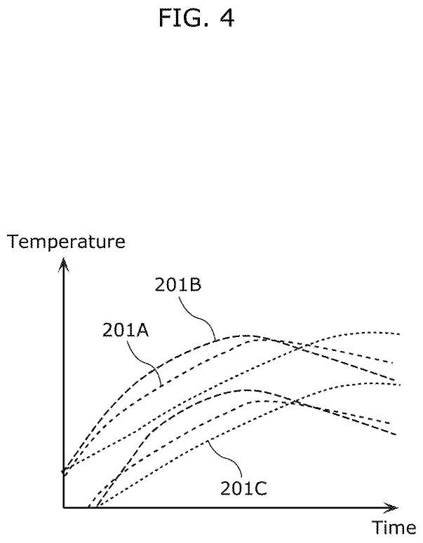

FIG. 4 is a diagram illustrating an example of a plurality of reference ranges stored in reference range storage 113. Note that although only the three reference ranges 201A, 201B, and 201C are illustrated in FIG. 4, the plurality of reference ranges may include reference ranges other than reference ranges 201A, 201B, and 201C. Here, the plurality of reference ranges each indicate a range between the upper value and the lower value obtained from a different model temperature waveform obtained in advance. For example, reference range 201A indicates the range between the upper value and the lower value obtained from a first temperature waveform that is a model temperature waveform and is obtained in advance, and reference range 201B indicates the range between the upper value and the lower value obtained from a second temperature waveform that is a model temperature waveform different from the first temperature waveform, and is obtained in advance.

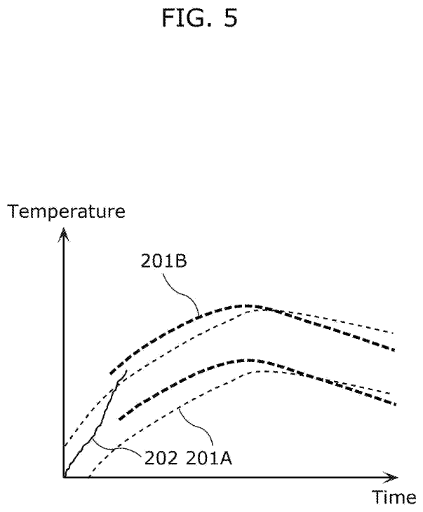

FIG. 5 is a diagram illustrating an example of an indication displayed on display 102 when measured waveform 202 exceeds the upper limit of reference range 201A. As illustrated in FIG. 5, when measured waveform 202 exceeds the upper limit of reference range 201A, display 102 displays reference range 201B.

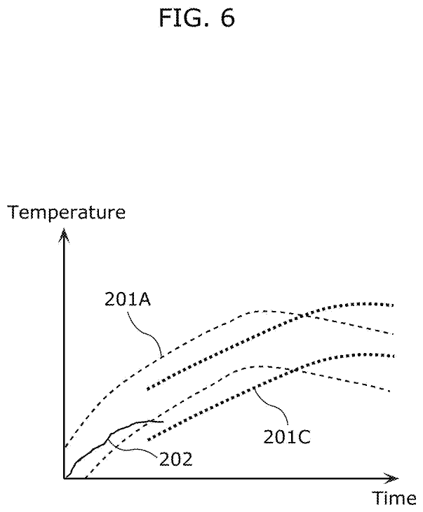

FIG. 6 is a diagram illustrating an example of an indication displayed on display 102 when measured waveform 202 falls below the lower limit of reference range 201A. As illustrated in FIG. 6, when measured waveform 202 falls below the lower limit of reference range 201A, display 102 displays reference range 201C. As such, a reference range displayed by display 102 when measured waveform 202 exceeds the upper limit of reference range 201A and a reference range displayed by display 102 when measured waveform 202 falls below the lower limit of reference range 201A are different.

For example, among the plurality of reference ranges stored in reference range storage 113, controller 114 displays, on display 102, a reference range having the highest correlation with measured waveform 202. Specifically, the correlation between measured waveform 202 up to the present time and a reference range up to the present time is calculated.

In addition, the correlation between measured waveform 202 and the reference range is the correlation between measured waveform 202 and a reference waveform that is the center line of the reference range, for example. In addition, it may be determined that the correlation is higher for a smaller sum of temperature differences between the reference waveform and measured waveform 202 at each time point, or for a smaller difference in time integral of temperatures, for example.

In addition, controller 114 may select (i) a reference range that includes the entirety of measured waveform 202 as the reference range for updating the current reference range, (ii) a reference range that includes the current temperature as the reference range for updating the current reference range, or (iii) a reference range having a time range that includes measured waveform 202 the most as the reference range for updating the current reference range.

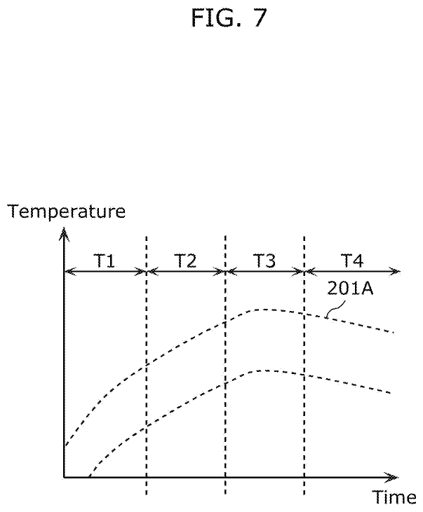

Furthermore, controller 114 may select a reference range for updating the current reference range, based on the level of skill of a worker and a time elapsed since the start of brazing work. FIG. 7 is a diagram illustrating an example of time intervals classified according to times elapsed since the start of brazing work. In the example illustrated in FIG. 7, times elapsed each are classified into any one of time intervals T1 through T4.

For example, controller 114 displays, on display 102, a different reference range according to a time interval including the time at which measured waveform 202 falls outside reference range 201A. In addition, controller 114 displays, on display 102, a different reference range according to the level of skill of a worker.

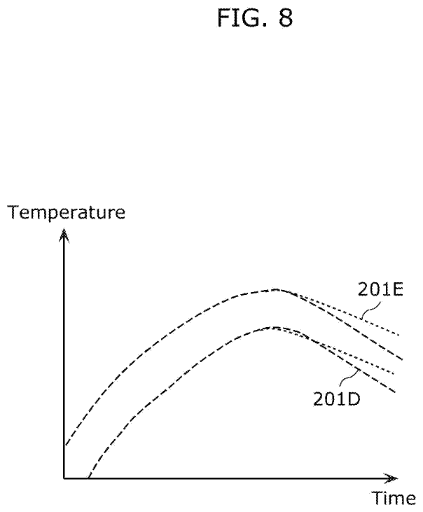

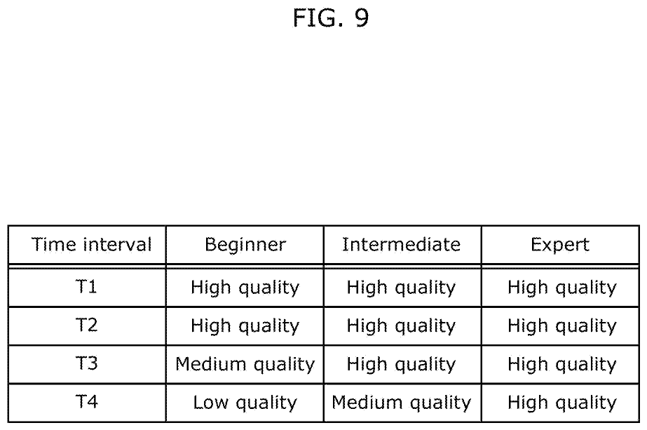

For example, each of time intervals is associated with a plurality of reference ranges. FIG. 8 is a diagram illustrating an example of a plurality of reference ranges that correspond to a plurality of levels of skill and are stored in reference range storage 113. FIG. 9 is a diagram illustrating an example of relationships between time intervals and the levels of skill of workers, and the qualities of work when the work is completed according to a reference range. Note that in the example, the three levels are used as the levels of skill of workers, which are a beginner, an intermediate, and an expert.

Reference range 201D illustrated in FIG. 8 is a reference range provided for a high quality of brazing work in time interval T3, and reference range 201E is a reference range provided for a medium quality of brazing work in time interval T3. Here, although the reference range provided for a high quality of brazing work is higher in quality than the reference range provided for a medium quality of brazing work, the level of work difficulty is also higher in the level of work for the reference range provided for a high quality of brazing work. Therefore, when the level of skill of a worker is low, the reference range provided for a medium quality work, for which the level of work difficulty is determined to be low, is displayed to prevent the worker from making mistakes (production of a defective product) in brazing work. For example, a reference range provided for a high level of work difficulty is a reference range in which a change in temperature is abrupt or the temperature range is narrow.

In addition, the later the time at which measured waveform 202 falls outside reference range 201A is, the more difficult it is to correct brazing work using a different reference range. Therefore, as illustrated in FIG. 8, controller 114 selects, for the first-half time intervals T1 and T2, the same reference range regardless of the level of skill of a worker. In contrast, controller 114 selects, for the last-half time intervals T3 and T4, a different reference range according to the level of skill of the worker. Specifically, controller 114 selects a reference range provided for a higher level of work difficulty for a worker having a higher level of skill. In other words, controller 114 selects a reference range provided for a lower level of work difficulty for a worker having a lower level of skill.

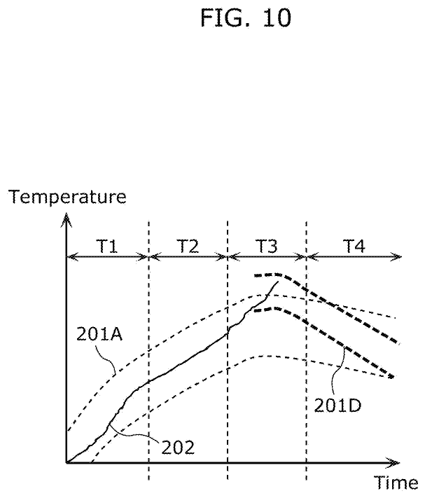

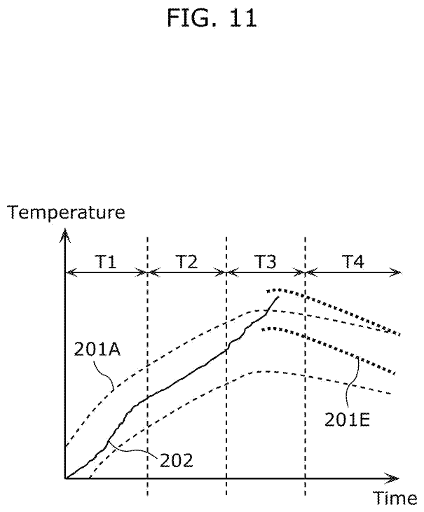

For example, when measured waveform 202 falls outside reference range 201A in time interval T3, and when a worker is an intermediate or an expert, reference range 201D that is associated with a high quality of brazing work is displayed as illustrated in FIG. 10. In contrast, when the worker is a beginner, reference range 201D that is associated with a middle quality of brazing work is displayed as illustrated in FIG. 11.

Specifically, when measured waveform 202 falls outside reference range 201A in time interval T3, controller 114 compares measured waveform 202 with the plurality of reference ranges, and selects reference range 201D and reference range 201E which have a high correlation with measured waveform 202, for example. Furthermore, controller 114 selects one of reference range 201D and reference range 201E according to the level of skill of a worker.

Note that although controller 114 determines a new reference range based on, for example, the correlation between measured waveform 202 and the plurality of reference ranges as described above, the method of determining a new reference range is not limited to the above. For example, a reference range that is to be selected when measured waveform 202 exceeds the upper limit of reference range 201A, and a reference range that is to be selected when measured waveform 202 falls below the lower limit of reference range 201A may be predetermined for each of the above-described time intervals. Note that these time intervals may be different from the time intervals illustrated in FIG. 9.

In addition, the types of levels of skill and the types of qualities of brazing work described above are mere examples. The number of types of levels of skill and the number of types of qualities of brazing work may be optional.

In addition, although the above has described the operation performed when measured waveform 202 falls outside the default reference range 201A, a new reference range may further be displayed in the same manner as the above when measured waveform 202 falls outside an updated reference range.

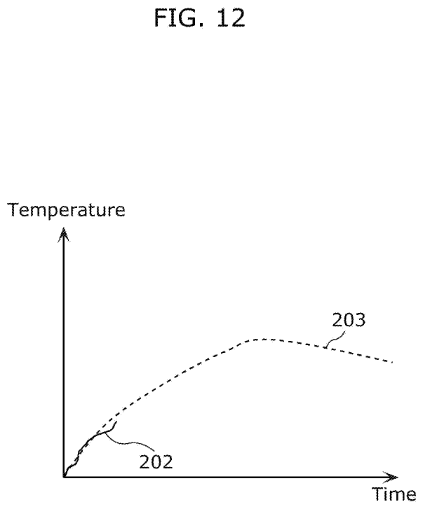

In addition, although the above has described an example in which a range having a temperature range is illustrated as a reference range, controller 114 may display, on display 102, reference waveform 203 that is a model temperature waveform having no temperature range. FIG. 12 is a diagram illustrating an example of an indication displayed on display 102 in this case. Reference waveform 203 may be the center line of a reference range described above. In this case, controller 114 updates reference waveform 203 that is displayed when measured waveform 202 falls outside a reference range corresponding to the currently displayed reference waveform 203. Alternatively, controller 114 may update reference waveform 203 that is displayed when a temperature difference between reference waveform 203 and measured waveform 202 is more than or equal to a predetermined threshold. Moreover, controller 114 may update reference waveform 203 that is displayed when the correlation between reference waveform 203 and measured waveform 202 falls below a predetermined threshold.

The above has described the example in which a reference range that is displayed is updated when measured waveform 202 falls outside a reference range. However, when there is a reference range having a higher correlation with the current measured waveform 202, compared to the correlation between the currently displayed reference range and the current measured waveform 202, controller 114 may determine the reference range having a higher correlation with the current measured waveform 202 to be the new reference range.

In addition, although reference range 201A subject to update is still displayed even after measured waveform 202 falls outside reference range 201A in FIG. 5 etc., reference range 201A need not be displayed. In addition, although only reference range 201B that covers a time period after the time at which measured waveform 202 falls outside reference range 201A is displayed as reference range 201B that has updated reference range 201A in FIG. 5 etc., reference range 201B that covers the whole time period may be displayed.

In addition, when there is no reference range that can update the current reference range because measured waveform 202 greatly falls outside all reference ranges, a worker may be notified of that situation, for example. For example, a notification is provided for the worker using at least one of a text, an image, a sound, a color, and vibration.

In addition, although an indication of information that is displayed on display 102 provides information for a worker as described above, a sound, vibration, etc. may further be used. In addition, when measured waveform 202 is likely to fall outside a reference range (i.e., when measured waveform 202 is included in the boundary area of the reference range), or when measured waveform 202 falls outside the reference range, at least one of a text, an image, a sound, a color, and vibration may be used to notify a worker of that situation.

That is, in the brazing work assistance method for assisting a worker in conducting brazing work according to the present disclosure, information for notifying a worker is outputted. The worker is notified of information about whether a measured waveform, which is a temperature waveform of a brazing portion brazed during brazing work conducted by a worker, is included in a first reference range that indicates a range between the upper value and the lower value obtained from a first temperature waveform. The first temperature waveform is obtained in advance and is a model temperature waveform of the brazing portion in the brazing work.

In addition, after the completion of work, brazing work assistance device 103 may estimate a work result based on measured waveform 202, and may notify a worker of the estimated work result. Here, the work result indicates whether a brazing work has resulted in the production of a non-defective product or a defective product, and the quality (e.g., a high quality, a medium quality, and a low quality) of brazing work when the brazing work has resulted in the production of a non-defective product. For example, brazing work assistance device 103 estimates the quality that is associated with a reference range having the highest correlation with measured waveform 202 to be the quality of brazing work to be indicated as a work result. In addition, brazing work assistance device 103 estimates that, as a work result, brazing work has resulted in the production of a defective product when the correlation between measured waveform 202 and each of the plurality of reference ranges is below a predetermined threshold.

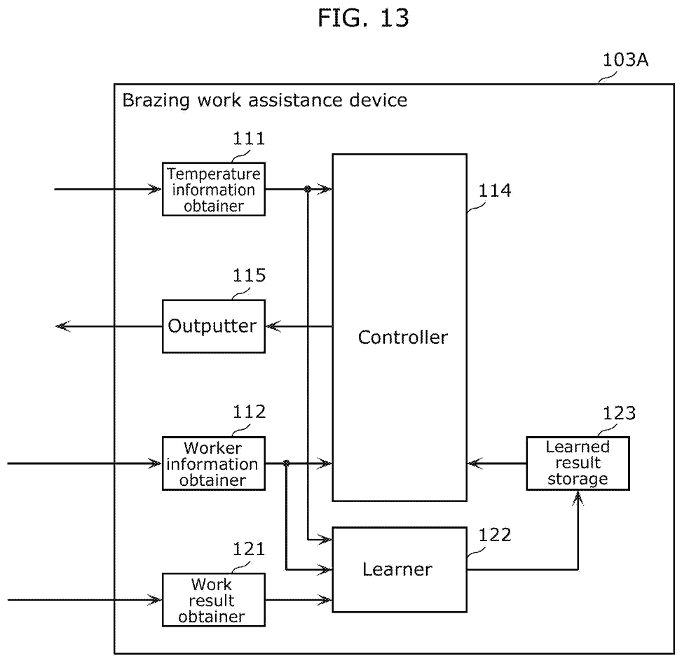

In addition, the plurality of reference ranges may be generated through machine learning. FIG. 13 is a block diagram illustrating an example of a configuration of brazing work assistance device 103A in this case. Brazing work assistance device 103A illustrated in FIG. 13 includes, in addition to the configuration of brazing work assistance device 103 illustrated in FIG. 1, work result obtainer 121 and learner 122. In addition, brazing work assistance device 103A includes learned result storage 123 instead of reference range storage 113.

Work result obtainer 121 obtains a work result of brazing work. This work result includes the information indicating whether brazing work has resulted in the production of a non-defective product or a defective product, and the information indicating the quality (e.g., a high quality, a medium quality, and a low quality) of brazing work when the brazing work has resulted in the production of a non-defective product.

Learner 122 performs machine learning using, as input, a plurality of sets of a measured waveform obtained by temperature information obtainer 111, the level of skill of a worker obtained by worker information obtainer 112, and a work result obtained by work result obtainer 121 to generate a plurality of reference ranges. Specifically, a plurality of reference ranges corresponding to each level of skill are generated.

Learned result storage 123 stores the plurality of reference ranges generated.

Controller 114 performs the same processing as described above using the plurality of reference ranges stored in learned result storage 123.

Note that a reference range for updating the current reference range may be generated from measured waveform 202 through machine learning. In other words, a method of generating a reference range for updating the current reference range from measured waveform 202 may be learned through machine learning. In this case, a work result achieved by a worker conducting work using a reference range that is generated by this method may be used for machine learning.

Learned results (coefficients of learning, etc.) obtained by learning are stored in learned result storage 123. By computing using a learned result, controller 114 generates a reference range for updating the current reference range from measured waveform 202, a level of skill, etc.

Note that although an example in which brazing work assistance device 103A includes a learning function is described here, brazing work assistance device 103A may obtain learned results that are obtained by another device performing machine learning.

Although the brazing work assistance system according to the embodiment of the present disclosure has been described as above, the present disclosure is not limited to the embodiment.

For example, although the embodiment has described the system that provides assistance for brazing work, the same method may be used for welding work other than brazing work. That is, the term “brazing” in the above descriptions may be replaced with the term “welding.”

For example, a welding work assistance method according to the present disclosure is a welding work assistance method for assisting a worker in conducting welding work. The welding work assistance method includes: displaying (i) a first reference range indicating a range between the upper value and the lower value obtained from a first temperature waveform that is a model temperature waveform of a welding portion in the welding work, and (ii) a measured waveform that is a temperature waveform of the welding portion welded during the welding work conducted by the worker, the first temperature waveform being obtained in advance; and displaying a second reference range according to the measured waveform when the measured waveform falls outside the first reference range. The second reference range indicates a range between the upper value and the lower value obtained from a second temperature waveform and is different from the first reference range. The second temperature waveform is a model temperature waveform of the welding portion in the welding work, is different from the first temperature waveform, and is obtained in advance.

For example, among a plurality of reference ranges, a reference range having the highest correlation with the measured waveform may be displayed as the second reference range.

For example, a reference range displayed as the second reference range when the measured waveform exceeds an upper limit of the first reference range and a reference range displayed as the second reference range when the measured waveform falls below a lower limit of the first reference range may be different.

For example, a different reference range may be displayed as the second reference range according to a level of skill of the worker.

For example, when a level of skill of the worker is a first level of skill, a third reference range may be displayed as the second reference range. When a level of skill of the worker is a second level of skill which is lower in the level of skill than the first level of skill, a fourth reference range may be displayed as the second reference range. The third reference range may indicate a range of a model temperature waveform for conducting a first quality of welding work. The fourth reference range may indicate a range of a model temperature waveform for conducting a second quality of welding work which is lower in quality than the first quality of welding work.

For example, when time elapsed since the start of the welding work is shorter than a predetermined reference time, the same reference range may be displayed as the second reference range regardless of the level of skill of the worker. When the time elapsed is longer than the predetermined reference time, a different reference range may be displayed according to the level of skill of the worker.

For example, the first reference range and the second reference range may be generated through machine learning.

For example, the second reference range may be generated from the measured waveform through machine learning.

For example, a welding work assistance system according to the present disclosure is a welding work assistance system that assists a worker in conducting welding work. In the welding work assistance system, (i) a first reference range indicating a range between the upper value and the lower value obtained from a first temperature waveform that is a model temperature waveform of a welding portion in the welding work, and (ii) a measured waveform that is a temperature waveform of the welding portion welded during the welding work conducted by the worker are displayed, the first temperature waveform being obtained in advance; and a second reference range according to the measured waveform is displayed when the measured waveform falls outside the first reference range. The second reference range indicates a range between the upper value and the lower value obtained from a second temperature waveform and is different from the first reference range. The second temperature waveform is a model temperature waveform of the welding portion in the welding work, is different from the first temperature waveform, and is obtained in advance.

In addition, each of processors included in the brazing work assistance device according to the above embodiment are typically implemented as a large-scale integration (LSI) circuit, which is an integrated circuit. These circuits each may be individually implemented as a single chip or may be implemented as a single chip including some or all of the circuits.

Circuit integration is not limited to LSI; elements may be implemented as a dedicated circuit or a generic processor. A field programmable gate array (FPGA) that is programmable after manufacturing of the LSI circuit, or a reconfigurable processor whose circuit cell connections and settings in the LSI circuit are reconfigurable, may be used.

Note that each of the structural elements in the above embodiments may be configured in the form of an exclusive hardware product, or may be implemented by executing a software program suitable for each structural element. Each of the structural elements may be implemented by means of a program executing unit, such as a CPU or a processor, reading and executing the software program recorded on a recording medium such as a hard disk or a semiconductor memory.

In addition, the present disclosure may be implemented as a brazing work assistance method implemented by the brazing work assistance system or the brazing work assistance device.

The block diagrams each illustrate one example of the division of functional blocks: a plurality of functional blocks may be implemented as a single functional block, a single functional block may be broken up into a plurality of functional blocks, and part of one function may be transferred to another functional block. Functions of a plurality of functional blocks having similar functions may be processed in parallel or by time-division by a single hardware or software product.

In addition, the configurations of devices included in the brazing work assistance system are mere examples. Instead, a plurality of processes performed in one device may be divided and performed by a plurality of devices, or the plurality of processes performed by the plurality of devices may be performed by a single device.

Moreover, the order in which the steps are executed in the flowcharts are mere examples for presenting specific examples of the present disclosure; the orders are not limited to the illustrated orders. Furthermore, some of the steps may be executed at the same time as (in parallel with) other steps.

The above has described the brazing work assistance system according to one or more aspects based on the embodiment, but the present disclosure is not limited to the above embodiment. Without departing from the scope of the present disclosure, various modifications which may be conceived by a person skilled in the art, and embodiments achieved by combining structural elements in different embodiments may be encompassed within the scope of one or more aspects the present disclosure.

### INDUSTRIAL APPLICABILITY

The present disclosure is applicable to a brazing work assistance system.

### REFERENCE SIGNS LIST

100 brazing work assistance system
101 temperature sensor
102 display
103, 103A brazing work assistance device
111 temperature information obtainer
112 worker information obtainer
113 reference range storage
114 controller
115 outputter
121 work result obtainer
122 learner
123 learned result storage
201A, 201B, 201C, 201D, 201E reference range
202 measured waveform
203 reference waveform

1. A brazing work assistance method for assisting a worker in conducting brazing work, the brazing work assistance method comprising:
displaying (i) a first reference range indicating a range between an upper value and a lower value obtained from a first temperature waveform that is a model temperature waveform of a brazing portion in the brazing work, and (ii) a measured waveform that is a temperature waveform of the brazing portion brazed during the brazing work conducted by the worker, the first temperature waveform being obtained in advance; and
displaying a second reference range according to the measured waveform when the measured waveform falls outside the first reference range, the second reference range indicating a range between an upper value and a lower value obtained from a second temperature waveform and being different from the first reference range, the second temperature waveform being a model temperature waveform of the brazing portion in the brazing work, being different from the first temperature waveform, and being obtained in advance.

2. The brazing work assistance method according to claim 1, wherein
among a plurality of reference ranges, a reference range having a highest correlation with the measured waveform is displayed as the second reference range.

3. The brazing work assistance method according to claim 1, wherein
a reference range displayed as the second reference range when the measured waveform exceeds an upper limit of the first reference range and a reference range displayed as the second reference range when the measured waveform falls below a lower limit of the first reference range are different.

4. The brazing work assistance method according to claim 1, wherein
a different reference range is displayed as the second reference range according to a level of skill of the worker.

5. The brazing work assistance method according to claim 4, wherein
when a level of skill of the worker is a first level of skill, a third reference range is displayed as the second reference range,
when a level of skill of the worker is a second level of skill which is lower in the level of skill than the first level of skill, a fourth reference range is displayed as the second reference range,
the third reference range indicates a range of a model temperature waveform for conducting a first quality of brazing work, and
the fourth reference range indicates a range of a model temperature waveform for conducting a second quality of brazing work which is lower in quality than the first quality of brazing work.

6. The brazing work assistance method according to claim 4, wherein
when time elapsed since a start of the brazing work is shorter than a predetermined reference time, a same reference range is displayed as the second reference range regardless of the level of skill of the worker, and
when the time elapsed is longer than the predetermined reference time, a different reference range is displayed according to the level of skill of the worker.

7. The brazing work assistance method according to claim 1, wherein
the first reference range and the second reference range are generated through machine learning.

8. The brazing work assistance method according to claim 1, wherein
the second reference range is generated from the measured waveform through machine learning.

9. A non-transitory computer-readable recording medium for use in a computer, the recording medium having a computer program recorded thereon for causing the computer to execute the brazing work assistance method according to claim 1.

10. A brazing work assistance system that assists a worker in conducting brazing work, wherein
(i) a first reference range indicating a range between an upper value and a lower value obtained from a first temperature waveform that is a model temperature waveform of a brazing portion in the brazing work, and (ii) a measured waveform that is a temperature waveform of the brazing portion brazed during the brazing work conducted by the worker are displayed, the first temperature waveform being obtained in advance; and
a second reference range according to the measured waveform is displayed when the measured waveform falls outside the first reference range, the second reference range indicating a range between an upper value and a lower value obtained from a second temperature waveform and being different from the first reference range, the second temperature waveform being a model temperature waveform of the brazing portion in the brazing work, being different from the first temperature waveform, and being obtained in advance.
